(19) United States
(12) Patent Application Publication
(10) Pub. No.: US 2005/0011945 A1
(43) Pub. Date: Jan. 20, 2005

(54) System and method for promoting fan loyalty using smart cards

(76) Inventors: James Claude Williams JR., Churchville, VA (US); Judy Evelyn Williams, Churchville, VA (US)

Correspondence Address: JAMES C. WILLIAMS, P.O. BOX 36, CHURCHVILLE, VA, 24421, US

(21) Appl. No.: 10/731,531

(22) Filed: Jul. 15, 2004

Related U.S. Application Data
(60) Provisional application No. 60/435,914, filed on Dec. 24, 2002.

(51) Int. Cl. G06F 17/60; G06K 5/00

(52) U.S. Cl. 235/380; 705/14

(57) ABSTRACT

A system, method and computer program product for applying smart card technology and related integrated operations to the sports and entertainment industry for the purpose of promoting fan loyalty to sports and entertainment celebrities. Purchasing, virtual touring, and virtual interaction with a celebrity is achieved through the provision of user services, storage of data, and user-friendly methods for ordering and shipping merchandise from a host computer Web store that is connected to a celebrity's personal Web site. The system, method and computer programs product rely on smart cards functioning with a smart card terminal to store data and to communicate on a plurality basis to transmit and receive data. The invention is also designed to facilitate navigation and enhance speed of access on the PC and Mac platforms.

THIS APPLICATION CLAIMS PRIORITY OVER PROVISIONAL APPLICATION No. 60/435,914, FILED DEC. 24, 2002, UNDER ATTORNEY DOCKET #3834-001-27 PROV.

### BACKGROUND OF THE INVENTION

1. Field of the Invention

The present invention relates generally to Internet Web sites and smart cards, and more particularly to systems that allow targeted purchasing and virtual touring and interaction while combining these two technologies.

2. Related Art

In today's technologically advanced world, there are two problems facing sports and entertainment fanatics (i.e., “fans”).

First, fans of sports and entertainment celebrities give their support and spend their money to demonstrate that support on a continuous basis without any tangible payback or benefits.

Second, Internet maneuverability and efficiencies limit how fans can search and shop on-line (i.e., over the World Wide Web). Today, fans—most of which have Internet access and use it regularly—must rely on third-party search engines and browser favorites lists (or bookmarks) to quickly find and access their favorite celebrities' fan club Web sites and associated Web pages. This problem is exacerbated by current on-line shopping norms which require a great amount of repetition. That is, Internet users who shop on-line find themselves repeatedly entering their login, password, credit card number, billing address, and shipping address (during the “checkout” process). This problem is further magnified for those users/fans who have different logins, passwords, etc. for different Web sites.

No known systems, methods, or computer program products have aimed to address the above-identified problems for sports and entertainment fans. Therefore, given the above, what is needed is a system, method and computer program product for promoting fan loyalty to sports and entertainment celebrities. The system, method and computer program should make use of smart card technology, coupled with the Internet, to facilitate the promotion of fan loyalty to sports and entertainment celebrities.

### DETAILED DESCRIPTION

Overview

The present invention meets the above-identified needs by providing a system, method and computer program product for promoting fan loyalty to sports and entertainment celebrities using smart cards. The features and advantages of the present invention will become more apparent from the detailed description set forth below when taken in conjunction with the figures.

In an embodiment, holders of a special fan loyalty smart card will be entitled to tangible rewards and discounts as payback for their fan loyalty to their chosen celebrities. Further, in an embodiment, a computer program product working in conjunction with the technological advances of the smart card allows purchasers to hold the key to accelerated Internet connections to their favorite celebrities' fan club Web sites and associated Web pages and enhanced, on-line shopping conveniences, as well as data storage and retrieval. In an alternate embodiment, special software programs are also offered (e.g., on-line homework help for children and other special programs related to the celebrities' special interests and fan outreach).

In an embodiment of the present invention, an administrative entity (i.e., an application service provider (ASP)) would provide hardware (e.g., Web server, smart card reading device, etc.), software (e.g., Internet browser plug-in software, etc.) infrastructure, smart cards, licensing authority, customer support, service agreements and billing mechanism to allow its subscribers (i.e., users/fans) to hold the key to accelerated Internet connections to their favorite celebrities' fan club Web sites and associated Web pages and enhanced, on-line shopping conveniences, as well as data storage and retrieval. Subscribers would sign-up for the smart card and associated benefits over the Internet (i.e., connecting to the entity's own Web site), the telephone or in person.

The present invention is now described in more detail herein in terms of the above example. This is for convenience only and is not intended to limit the application of the present invention. In fact, after reading the following description, it will be apparent to one skilled in the relevant art(s) how to implement the following invention in alternative embodiments (e.g., other promotions not involving sports and entertainment celebrities). The terms “user,” “consumer,” “subscriber,” “fanatic,” “fan,” and the plural form of these terms may be used interchangeably throughout herein to refer to those who would access, use, and/or benefit from the tool that the present invention provides for promoting fan loyalty to sports and entertainment celebrities using smart cards.

As used herein, “smart card” refers to a plastic card (typically resembling a credit card) with an embedded integrated circuit (IC), which offers memory and microprocessing capabilities. Any given smart card can have one or both of two different interfaces—“contact” and “contact less.” A contact smart card requires physical contact with a card reading device in order to exchange data, whereas a contact less smart card transmits and receives data without requiring physical contact with a card reading device (e.g., by using radio frequency (RF) technology or the like).

Description

In an embodiment, multiple user platforms (e.g., an IBM™ or compatible personal computer (PC) running the Microsoft® Windows 95/98™ or Windows NT™ operating system, a Macintosh® computer running the Mac® OS operating system or the like) are supported in combination with a smart card programmed to enhance and facilitate Internet maneuverability and efficiency for the cardholder. In an embodiment, this blending of smart card technology with the computer program product of the present invention provides seamless and instant access to the celebrities' fan club Web pages, a Web store operated by the ASP, and links to services, such as on-line shopping and shipping, travel and related services, and special interest pages (e.g., homework help pages for students from grades K-12).

In an embodiment, the ASP would distribute special programmed code logic that is written to a CD-ROM disc or other media and then transferred to the consumer's PC hard drive or the like. In alternate embodiments, the software can be downloaded from the ASP's Web site directly. Once loaded, the software now residing on the hard drive has code logic therein that allows the software to communicate with the user's terminal (i.e., PC, Mac or the like) and read what is on the smart card and load new data to the card. When the card is inserted in the terminal, it communicates with the terminal through the software, and the software communicates with the browser. The code logic on the card allows for an instantaneous link to a celebrity's Web site.

As will be also apparent to one skilled in the relevant art(s) after reading the description herein, the ASP would make several different plug-ins available, based on the processor, operating system and/or the specific browser being used by the subscriber.

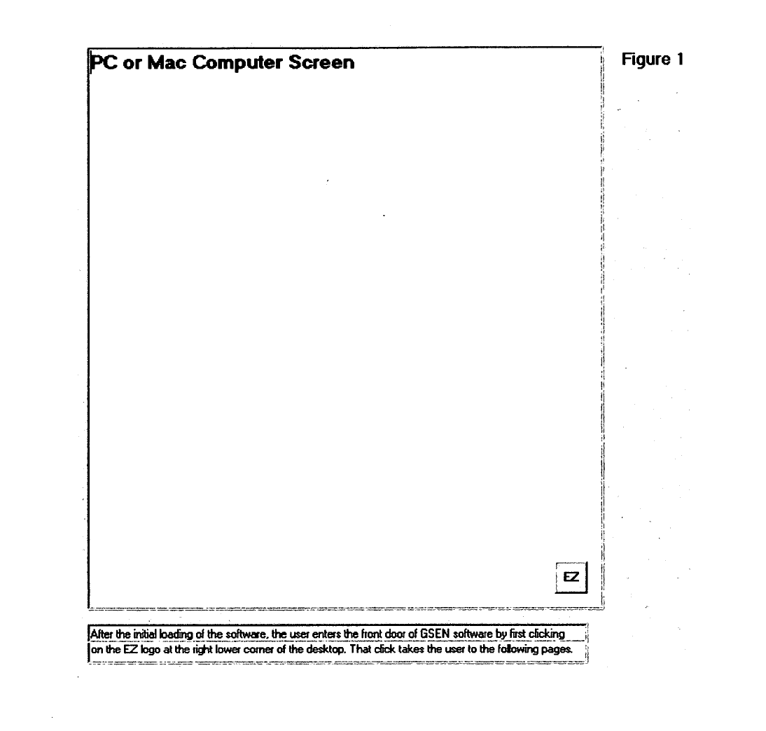

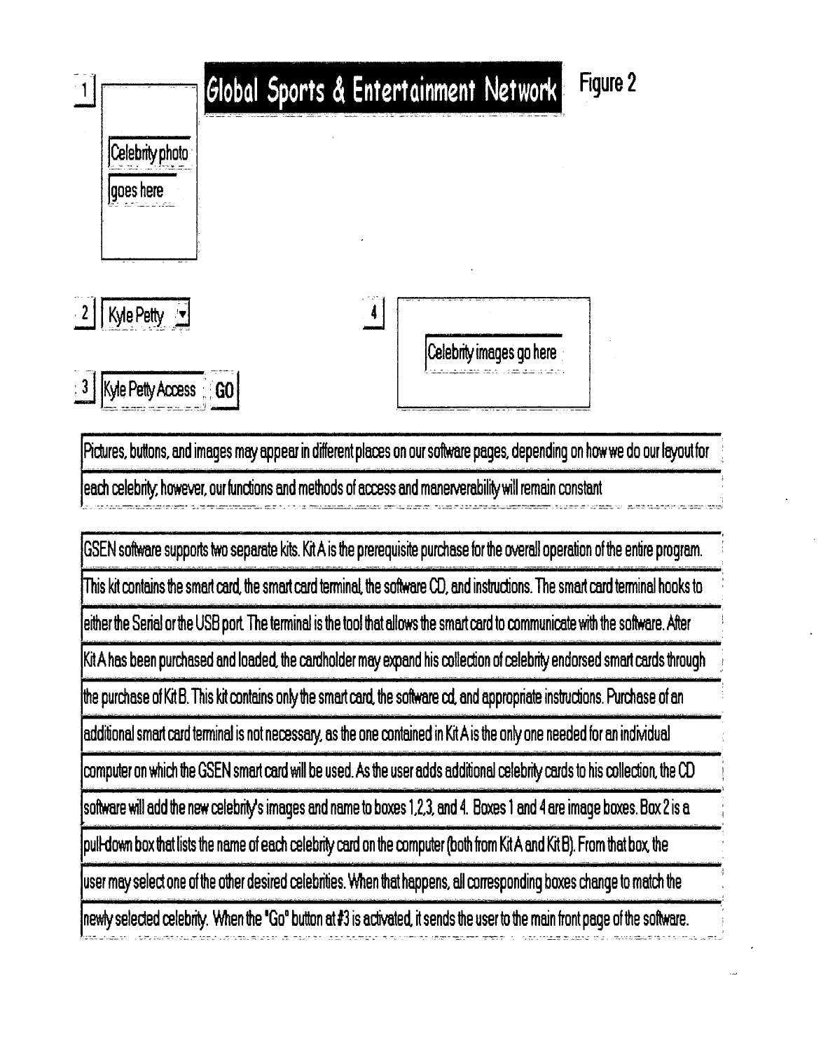

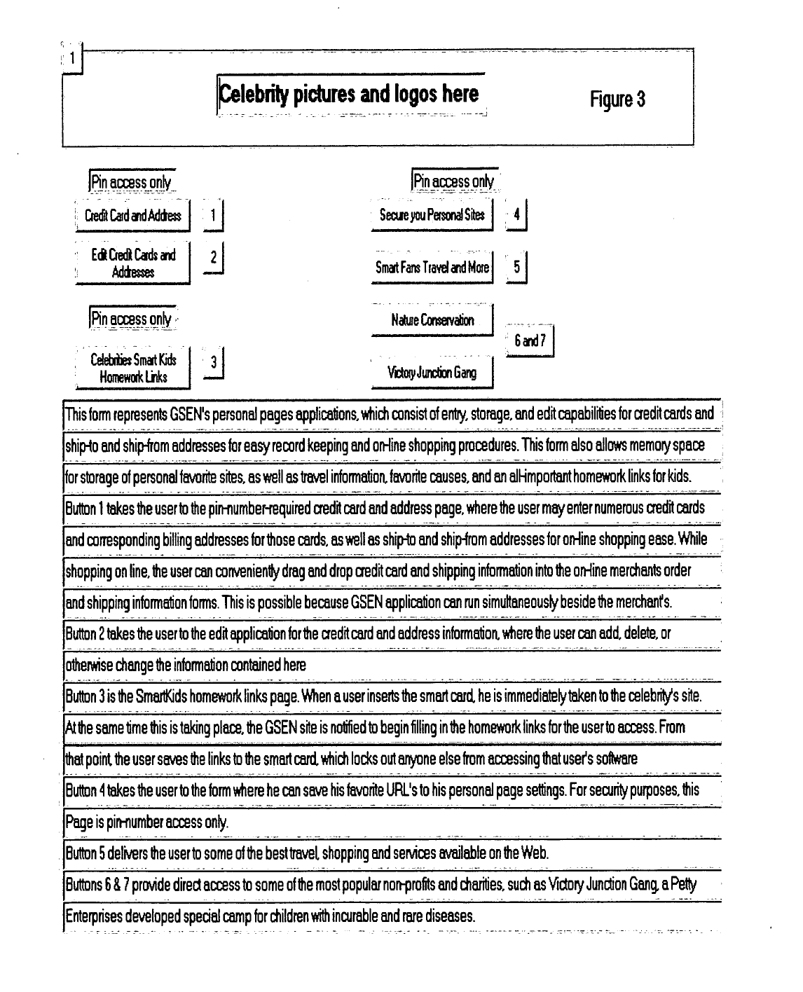

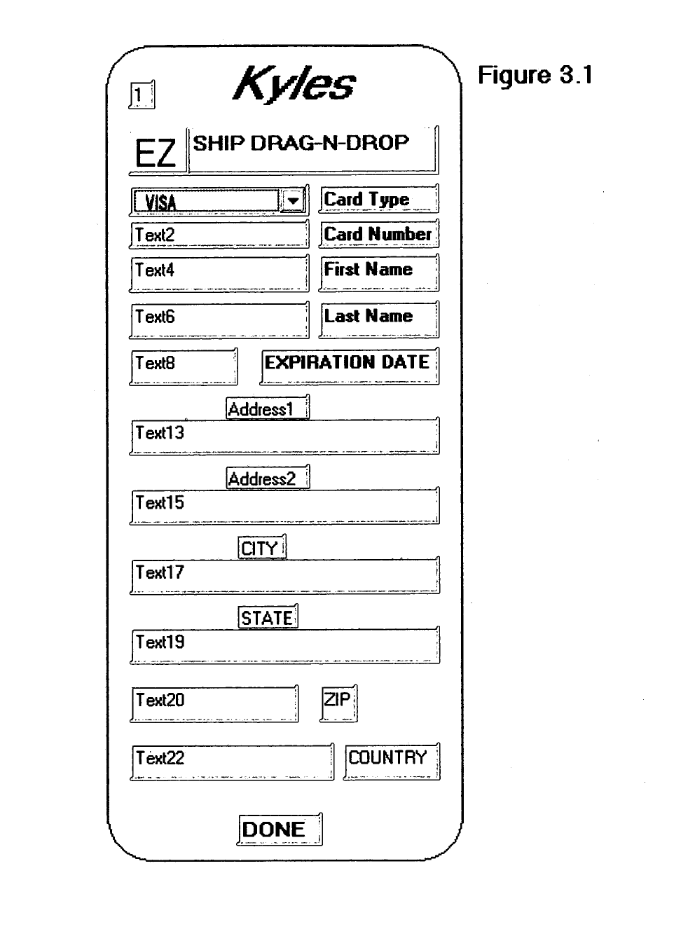

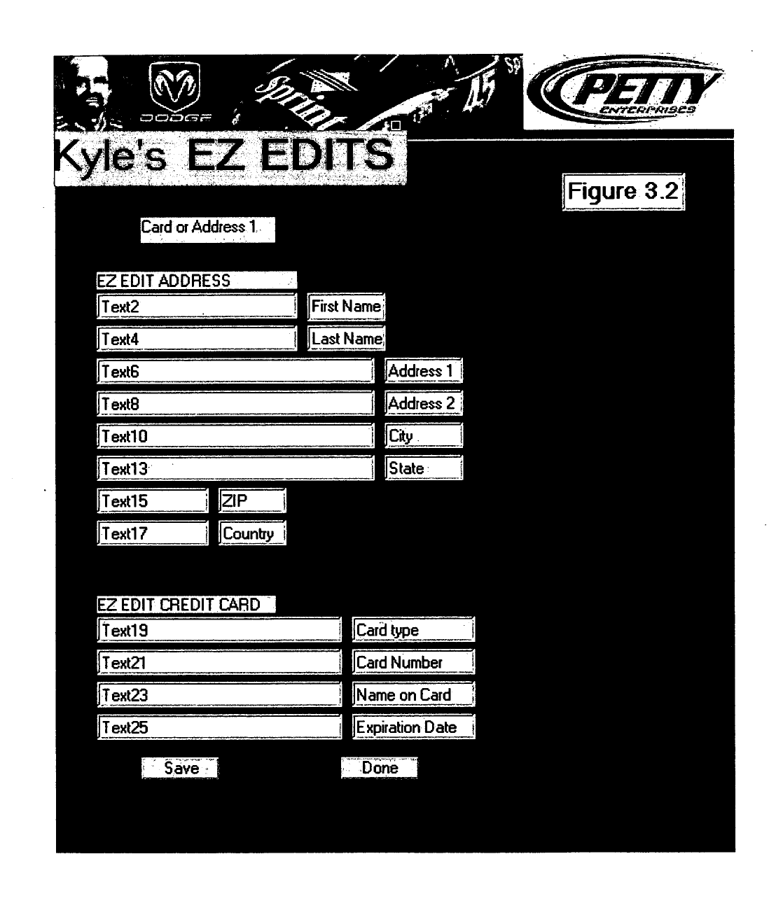

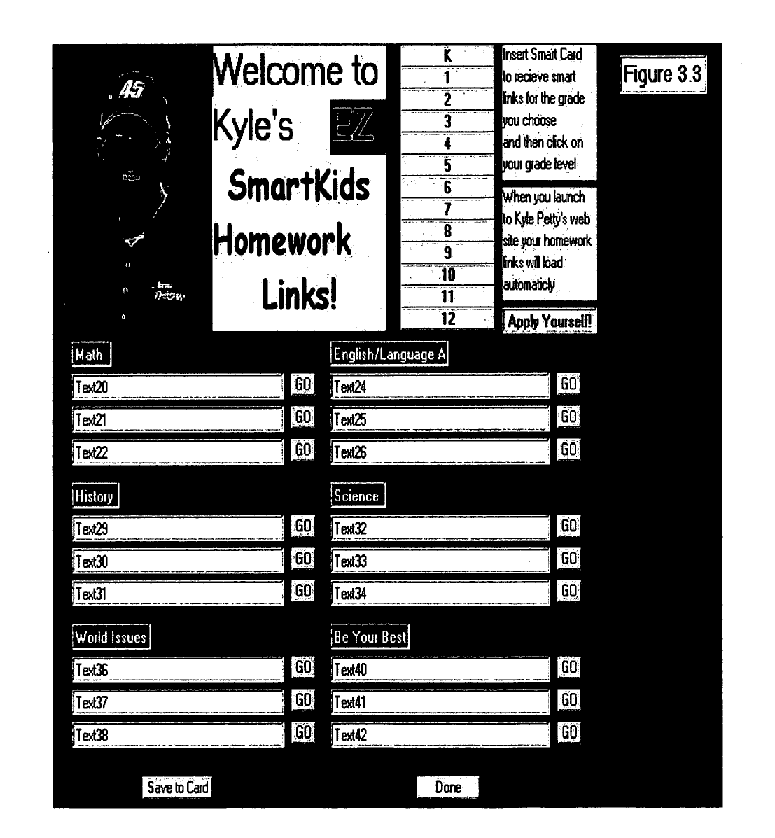

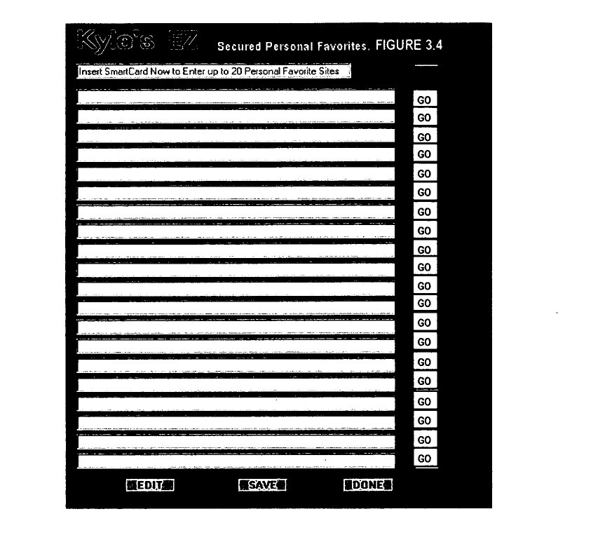

In an embodiment, updates from the ASP keep the fans' (i.e., cardholders') discounts and rewards packages current. Through a graphical user interface (GUI) on the ASP's own Web site component (FIG. 1), cardholders can enter (FIG. 3) and save to the smart card their favorite, password-protected URLs, as well as information for multiple credit cards, and on-line shipping and billing information (FIG. 3.2). In an embodiment, the user may access an easy (“EZ”) ship drag and drop application (FIG. 3.1) to transfer the previously-entered information to an on-line ordering form, thus expediting the online shopping process. In yet another embodiment, the helpful homework links (FIG. 3.3) component connects younger users to educational Universal Resource Locators (URLs) that will save hours of searching time. In addition, the users may update and expand these helpful URLs with others of their choosing. (FIG. 3.4).

In an embodiment, access to travel and pleasure discounts are available to cardholders by merely clicking on a “Travel and More” button (FIG. 3.5), which will take them to links and instructions for airline, car rental, hotel, and dining discounts.

In addition, cardholders can access non-profit and charitable sites using the loaded ASP software.

In an embodiment, the smart cards distributed by the entity have a photographic image of a sports or entertainment celebrity and are available (either by sale or free giveaway) in two “kits” (FIG. 2). A first, “starter kit” contains the smart card, the smart card terminal, and a CD-ROM or other media with the above-described software. As will be appreciated by those skilled in the relevant art(s) after reading the description herein, in an embodiment, a variety of commercially-available smart card readers may be employed by the present invention. Once the fan purchases the starter kit and connects the smart card terminal to their PC or the like (either via a serial port, Universal Serial Bus (USB) port or the like), the fan can expand their loyalty card collection with an “expansion kit” which contains only an additional smart card and CD-ROM or other media with another version of the above-described software which is programmed to provide instant fan page connection with the sports or entertainment celebrity featured on the additional smart card.

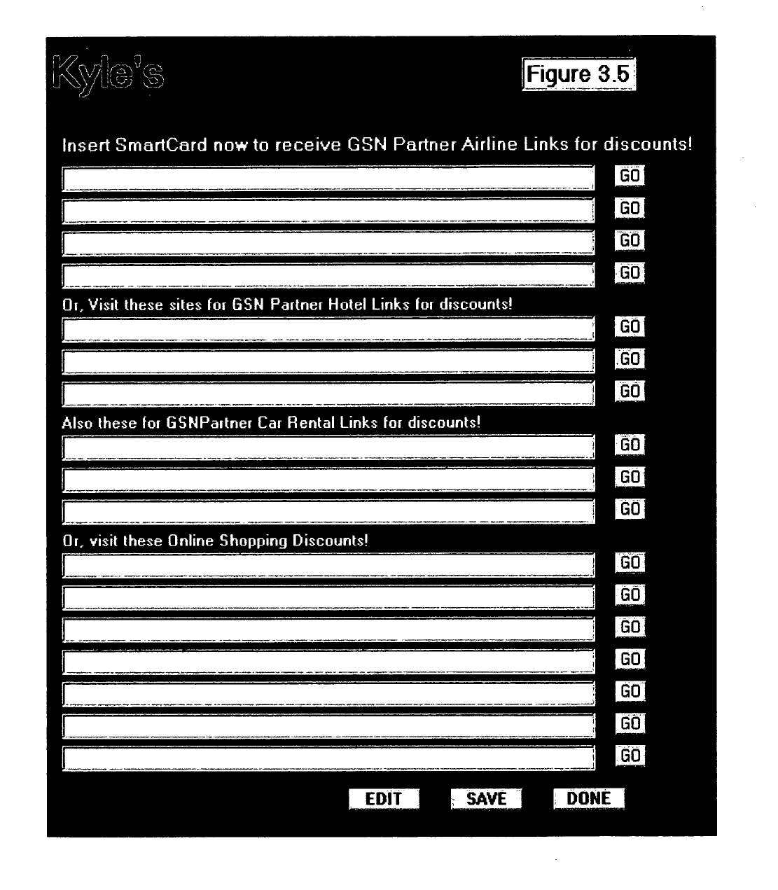

FIG. 5 presents a flowchart depicting one embodiment of the operational process of the method and computer program product for promoting fan loyalty to sports and entertainment celebrities using smart cards of the present invention.

Example Implementations

The present invention (and/or any part(s) or function(s) thereof) may be implemented using hardware, software or a combination thereof and may be implemented in one or more computer systems or other processing systems. In fact, in one embodiment, the invention is directed toward one or more computer systems capable of carrying out the functionality described herein. An example of a computer system 400 is shown in FIG. 4.

Computer system 400 includes one or more processors, such as processor 404. The processor 404 is connected to a communication infrastructure 406 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from the communication infrastructure 406 (or from a frame buffer not shown) for display on the display unit 430.

Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well known manner. Removable storage unit 418, represents a floppy disk, magnetic tape, optical disk, etc. which is read by and written to by removable storage drive 414. As will be appreciated, the removable storage unit 418 includes a computer usable storage medium having stored therein computer software and/or data.

In alternative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 414, a hard disk installed in hard disk drive 412, and signals 428. These computer program products provide software to computer system 400. The invention is directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 404 to perform the features of the present invention. Accordingly, such computer programs represent controllers of the computer system 400.

In an embodiment where the invention is implemented using software, the software may be stored in a computer program product and loaded into computer system 400 using removable storage drive 414, hard drive 412 or communications interface 424. The control logic (software), when executed by the processor 404, causes the processor 404 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### CONCLUSION

It should be understood that FIGS. 1-5, which highlight the functionality and other advantages of the present invention, are presented for example purposes only. The architecture of the present invention is sufficiently flexible and configurable such that users may utilize the invention in ways other than that shown in FIGS. 1-5 (e.g., the use of different screen formats, varying process step orderings, and the like).

While various embodiments of the present invention have been described above, it should be understood that they have been presented by way of example and not limitation. It will be apparent to persons skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

1. A system, method and computer program product for promoting targeted purchasing and fan loyalty to sports and entertainment celebrities—and the products and causes they promote and endorse—through the use of:
an embedded integrated circuit (IC) device, such as that found in the smart card and other devices using IC technology, which offers fans of sports and entertainment celebrities memory and microprocessing capabilities (including “contact” and “contact-less” devices) and which either displays or contains the images, names, logos, or other identifying monikers and/or elements of celebrities on or in any device using IC technology;
an application service provider (ASP) for all hardware, software, and infrastructure needs and support, including data base management;
a smart card terminal or other IC technology reading device connected either to the user's PC or Macintosh computer, or a merchant's terminal;
a computer program product working in conjunction with smart cards and other IC devices that provide the fans seamless and instant Internet connection to the chosen celebrities' fan club Web sites as a point of entry to the Web, a Web store operated by an application service provider (ASP), maneuverability and efficiencies while searching and shopping on the Web, and tangible, on or off-line paybacks and benefits in return for the fans' loyalty to their chosen celebrities;
a set of special software programs offering password-protected, hierarchical access to not only the celebrities' fan club pages, but also to the celebrities' preferred cross-marketing links, as well as downloadable and updatable homework help links for students, fan rewards for travel and related services, and data storage and retrieval, such as ship-to and bill-to names and addresses for convenience when shopping on-line, and for storage of the individual's favorite web site Universal Resource Locators (URLs);

2. The smart card or other integrated circuit (IC) system as defined in claim 1 uses multiple user platforms—including but not limited to an IBM™ or compatible personal computer (PC) running the Microsoft® Windows 95/98™ or Windows NT™ operating system, a Macintosh® computer running the Mac® OS operating system or the like—in combination with a programmed—and programmable—smart card, or other IC device, to facilitate and enhance not only Internet maneuverability, efficiencies, and services for the fan, but also off-line benefits for shopping, travel, dining, car rentals, and related services, when conducted in conjunction with participating merchants.

3. The system as defined in claim 1 distributes special programmed code logic through a CD-Rom disc, or other media, to the fan's hard drive, enabling the fan's computer terminal to read what is on the smart card and to download additional software directly from the ASP's web site, once the card is inserted into the terminal.

4. The system as defined in claim 1 allows for updates from the ASP that keep the fans' discounts and rewards packages current through a graphical user interface (GUI) on the ASP's web site component, which allows fans to enter and save to the smart card their favorite, password-protected Universal Resource Locators (URLs), multiple credit card account information (including other smart cards), and “ship to” and “bill to” drag and drop information.

5. The special software programs as defined in claim 1 reside on the user's hard drive—once they are loaded into the hard drive, either through CD-Rom or other such device, or through a direct download from the ASP's Web site—and use the code logic therein that allows the software to communicate with the user's terminal, read what is on the smart card, and load new data to the card.

6. The special software programs as defined in claim 1 use the invention's EZ Net program to access the SmartKids Homework Links component of the invention—connecting younger users to programmed, educational URLs and saving hours of searching time—and allowing for downloading of the user's personal choice URLs.

7. The special software programs as defined in claims 1, 5 and 6 communicate with the smart card once it is inserted into the terminal, and the software communicates with the browser, first taking the user instantly and seamlessly to the celebrity's fan club Web site, then to related links accessed from that Web site.

8. The method as defined in claim 1 relates to distributing the smart card either through a starter kit containing the card with the celebrity's photographic image, name, logo, or other identifying moniker or symbol, a program CD-Rom, and a smart card terminal or reader, or through an expansion kit containing only the celebrity smart card and program CD-Rom.

9. The method as defined in claim 1 relates to using an embedded integrated circuit (IC) device, such as a smart card, as the vehicle for connecting fans to their favorite sports and entertainment celebrities and providing those fans with both on and off-line rewards and paybacks for their loyalty to their chosen celebrities.
